(19) United States
(12) Patent Application Publication
(10) Pub. No.: US 2025/0189366 A1
(43) Pub. Date: Jun. 12, 2025

(54) SYSTEMS AND METHODS FOR INVESTIGATING OPTICAL INPUTS

(71) Applicant: Aston University, Birmingham West Midlands (GB)

(72) Inventor: David Benton, Birmingham West Midlands (GB)

(73) Assignee: Aston Triangle, Birmingham West Midlands (GB)

(21) Appl. No.: 19/056,043

(22) Filed: Feb. 18, 2025

Related U.S. Application Data
(63) Continuation of application No. PCT/EP2023/072627, filed on Aug. 16, 2023.

(30) Foreign Application Priority Data
Aug. 19, 2022 (GB) 2212110.7

(51) Int. Cl. G01J 1/04; G01J 1/42; G01J 1/44

(52) U.S. Cl. CPC G01J 1/0411; G01J 1/0448; G01J 1/44; G01J 2001/4242; G01J 2001/448

(57) ABSTRACT

A system includes a micromirror arranged to receive and reflect an optical input. The micromirror is adapted to tilt between a first position and a second position. The system also includes an optical sensor array arranged to receive light reflected by the micromirror at a position between the first position and at the second position and a processor in communication with the micromirror and the optical sensor array. The processor is adapted to control the micromirror to tilt between the first position and the second position when the optical input is received, thereby sweeping the reflected light across the optical sensor array to generate a swept light signal at the optical sensor array, and determine a temporal characteristic of the optical input based on the swept light signal.

### CROSS-REFERENCES TO RELATED APPLICATIONS

This application claims priority to and is a continuation of International Patent Application No. PCT/EP2023/072627, filed Aug. 16, 2023, which claims priority to GB Patent Application No. 2212110.7, filed Aug. 19, 2022, the entire contents of which are hereby incorporated by reference in their entirety for all purposes.

### FIELD OF THE INVENTION

The present invention relates to systems and methods for investigating optical inputs and particularly, although not exclusively, to systems and methods for determining a temporal characteristic of an optical input.

### BACKGROUND OF THE INVENTION

Digital micromirror devices (DMDs) are devices comprising an array of rapidly tilting micromirrors, which have found a primary role within digital projection technology. A typical DMD comprises an array of around 1 million addressable mirrors, each with a size of the order of 10 μm, which tilt between a first position and a second position, thereby providing a binary method of spatial light modulation.

The micromirrors of a DMD can typically be flipped between the first and second positions at rates of 10's of kHz and this modulation speed is a significant advantage over alternative spatial light modulators (SLMs), such as liquid crystal-based devices which will achieve only a few hundred Hz. This rapid binary modulation may be used to provide controlled intensity levels through a pulse width modulation approach.

The versatility of the DMD, its rapid modulation rate, insensitivity to polarization, relatively low cost and robust nature have led to a diverse range of uses. Applications of DMDs include: spectroscopy; switching; single pixel remote sensing; laser glare suppression; beam steering; wavelength measurement; and coherence measurement to name a selection.

The DMD has also found applications in biophotonics and healthcare. A popular area of application of DMDs within physical sciences is wavefront control as the DMD is able to produce mode structures leading to Laguerre-Gaussian and Hermite-Gaussian beams, orbital angular momentum vortex beams and perform wavefront control using Zernike modes for atmospheric wavefront generation or improving beam quality.

The speed and spatial addressing of the DMD device are properties that clearly benefit its use as an SLM, but one characteristic property that has seen very little utilization is that of the rapid angular sweep that accompanies the micromirrors tilting from the first position to the second position.

However, the diffraction pattern resulting from the interaction of light with a DMD is messy and complicated. Diffraction of the reflected light into a number of orders is responsible for the relatively poor efficiency of the DMDs. The efficiency of DMDs is dependent upon the angle of incidence of the light but can typically be <10%. The collective diffraction behavior of the mirrors results in specific orders being present and as the mirror sweeps the reflected intensity transitions between orders, rather than a desirable continuous transition.

There is therefore a need for a means of interpreting the characteristics of light reflected by DMDs during the micromirror sweep in a more accurate and efficient manner.

The present invention has been devised in light of the above considerations.

### SUMMARY OF THE INVENTION

In accordance with an aspect of the invention, there is provided a system for determining a temporal characteristic of a received light signal, the system comprising: a micromirror arranged to receive and reflect an optical input, wherein the micromirror is adapted to tilt between a first position and a second position; an optical sensor array arranged to receive light reflected by the micromirror at a position between the first position and at the second position; and a processor in communication with the micromirror and the optical sensor array, wherein the processor is adapted to: control the micromirror to tilt between the first position and the second position when the incoming light signal is received, thereby sweeping the reflected light across the optical sensor array to generate a swept light signal at the sensor array; and determine a temporal characteristic of the optical input based on the swept light signal.

The invention provides a means of determining a temporal characteristic of an incoming light signal in an efficient and accurate manner.

In particular, the invention provides a system for analyzing the evolution of a light signal over time in a near instantaneous manner. Accordingly, the system provides a means of investigating a characteristic light source from a single emittance, meaning that even unstable light sources, such as decaying plasmas, may be fully investigated without requiring multiple light emittances.

Put another way, the invention provides a means of characterizing an aspect, and in particular a temporal aspect, of an incoming light signal by sweeping the incoming light signal across the surface of a sensor array by way of a micromirror.

In other words, the system reflects the incoming light signal onto a light sensor array using a rapidly moving mirrored surface, which causes the reflected light signal to be spread over the surface of the sensor array. The intensity of the signal measured by the light sensor array at different points on the sensor array surface may then be analyzed in order to derive a temporal characteristic of the light signal.

In one or more embodiments, the optical sensor array comprises a camera sensor. In this way, the system may utilize a monochrome or full color camera sensor for capturing the swept light signal.

In one or more embodiments, the micromirror is further adapted to tilt between the second position and the first position, and wherein the processor is further adapted to: control the micromirror to tilt between the first position and the second position and between the second position and the first position when the incoming light signal is received, thereby sweeping the reflected light across the optical sensor array to generate an extended swept light signal at the sensor array; and determine a temporal characteristic of the optical input based on the extended swept light signal.

In this way, the system may utilize the full range of movement of the micromirror in order to generate a swept light signal having a greater dynamic range.

In one or more embodiments, the system comprises a plurality of micromirrors adapted to receive the incoming light signal, wherein each micromirror of the plurality of micromirrors is adapted to tilt between a first position and a second position. In this way, additional temporal information may be extracted from the swept light signal.

In one or more embodiments, the plurality of micromirrors is arranged in a one-dimensional array.

In one or more embodiments, the tilting of the micromirror from the first position to the second position defines a sweep path having a sweep angle between a first axis, which is an axis normal to the plane defined by the surface of the mirror at the first position, and a second axis, which is an axis normal to the plane defined by the surface of the mirror at the second position, and wherein the one-dimensional array is arranged orthogonal to the sweep path. In this way, the swept light signal may be simplified for the purposes of interpretation.

In one or more embodiments, the plurality of micromirrors is arranged in a two-dimensional array. In this way, additional temporal information may be extracted from the swept light signal.

In one or more embodiments, determining the temporal characteristic of the received light signal comprises determining a reflected pattern of the swept light signal.

By interpreting the reflected pattern of the swept light signal, the temporal characteristic of the received light signal may be determined in an accurate and efficient manner.

In one or more embodiments, determining the reflected pattern of the swept light signal comprises determining a diffraction pattern of the swept light signal by applying a blazed diffraction grating model to the swept light signal, wherein the blazed diffraction grating model comprises a model of a diffraction pattern from a blazed diffraction grating.

By interpreting the reflected pattern as a diffraction pattern, and in particular using a blazed diffraction grating model, the temporal characteristic of the received light signal may be determined in an accurate and efficient manner.

In one or more embodiments, the blazed diffraction grating model comprises a time varying blaze angle function, wherein a blaze angle of the blazed diffraction grating model changes over time as the plurality of micromirrors tilt from the first position to the second position.

By using a time varying blazed diffraction grating model, the temporal characteristic of the received light signal may be determined in an accurate and efficient manner.

In one or more embodiments, the system further comprises a diffraction grating provided between the optical input and the micromirror, and wherein the processor is further adapted to determine a spatial characteristic of the received light signal based on the swept light signal. In this way, both spatial and temporal characteristics of the optical input can be determined by the system.

In one or more embodiments, determining the spatial characteristic of the received light signal comprises one or more of: determining a spectral dispersion of the swept light signal; and determining a source dispersion of the optical input based on the swept light signal.

In one or more embodiments, the diffraction grating is a blazed grating.

According to an aspect in accordance with the invention, there is provided a spectrometer comprising the system as described above.

In one or more embodiments, the system further comprises a light source adapted to generate an output light signal and wherein the optical input is a reflection of the output light signal from a surface external to the system.

In one or more embodiments, the temporal characteristic comprises a time-of-flight measurement.

In one or more embodiments, the system comprises an optical fiber circulator adapted to: receive the generated output light signal from the light source; output a plurality of output light signals based on the received generated output light signal; and receive a plurality of reflected light signals as optical inputs.

In one or more embodiments, the plurality of optical inputs is provided to the micromirror, and wherein the processor is adapted to determine a plurality of time-of-flight measurements from a plurality of swept light signals.

According to an aspect in accordance with the invention, there is provided a LiDAR device comprising the system as described above.

According to an aspect in accordance with the invention, there is provided a computer implemented method for determining a temporal characteristic of a received light signal, the method comprising: controlling a micromirror to tilt between a first position and a second position when an optical input is received, wherein the micromirror is adapted to receive and reflect the optical input; obtaining a swept light signal from an optical sensor array arranged to receive light reflected by the micromirror at a position between the first position and at the second position; and determining the temporal characteristic of the incoming light signal based on the swept light signal.

In one or more embodiments, the method comprises controlling each of a plurality of micromirrors to tilt between a first position and a second position when the optical input is received.

In one or more embodiments, determining the temporal characteristic of the received light signal comprises determining a reflected pattern of the swept light signal.

In one or more embodiments, determining the reflected pattern of the swept light signal comprises determining a diffraction pattern of the swept light signal by applying a blazed diffraction grating model to the swept light signal, wherein the blazed diffraction grating model comprises a model of a diffraction pattern from a blazed diffraction grating.

In one or more embodiments, the blazed diffraction grating model comprises a time varying blaze angle function, wherein a blaze angle of the blazed diffraction grating model changes over time as the plurality of micromirrors tilt from the first position to the second position.

In one or more embodiments, determining the temporal characteristic of the received light signal comprises analyzing an intensity profile of the swept light signal.

The invention includes the combination of the aspects and preferred features described except where such a combination is clearly impermissible or expressly avoided.

### BRIEF DESCRIPTION OF THE DRAWINGS

Embodiments and experiments illustrating the principles of the invention will now be discussed with reference to the accompanying figures in which:

FIG. 1A shows a schematic representation of how the direction cosines of incoming and diffracted beams are represented.

FIG. 1B shows a schematic representation of the direction cosines of incoming and diffracted beams for a one-dimensional vertical diffraction grating.

FIG. 1C shows a schematic representation of the direction cosines of incoming and diffracted beams for a one-dimensional horizontal diffraction grating.

FIG. 1D shows a schematic representation of the direction cosines of incoming and diffracted beams for a two-dimensional diffraction grating.

FIG. 2A shows a representation of how the full cosine space may be populated with diffraction orders.

FIG. 2B shows a representation of how the full cosine space is populated with diffraction orders when the micromirrors are in the first and second positions.

FIG. 2C shows a saturated version of the center of the full diffraction order space shown in FIG. 2A.

FIG. 3 shows a plot of relative intensity again relative diffraction order, which represents the diffraction order distribution of a micromirror array during a transition between the first and second positions.

FIG. 4 shows a schematic representation of a system for controlling a micromirror according to an aspect of the invention.

FIG. 5A shows a series of images illustrating the reflected beams from a single micromirror transitioning from the first position to the second position at different delay times.

FIG. 5B shows a plot of the distance between the beams reflected by the micromirror in the first position and the during the transition between the first position to the second position.

FIG. 6 shows a schematic representation of a system for determining a temporal characteristic of a received light signal according to an aspect of the invention.

FIG. 7 shows a series of images illustrating the reflected beams received at the sensor array of FIG. 6 for differing light source delay times.

FIG. 8A shows a graph of projected intensity against screen position showing plots illustrating of vertical projections of intensity distribution for images with differing optical input pulse widths.

FIG. 8B shows a plot of projected image width against optical input pulse width.

FIG. 9A shows a captured diffraction pattern from a two-dimensional array of micromirrors.

FIG. 9B shows a set of projected vertical intensities showing how the intensity of the diffraction pattern evolves for delay increments of 10 ns

FIG. 9C shows a plot of centroid position of the diffraction pattern against delay.

FIG. 10 shows a schematic representation of a system for determining a temporal characteristic and a spectral characteristic of a received light signal according to an aspect of the invention.

FIG. 11 shows an image illustrating the chromatic dispersion of red, green and blue continuous lasers from a photo of the dispersing glass plate in FIG. 10.

FIG. 12 shows an image of the diffraction pattern of a pulsed white LED showing spectral and temporal dispersion.

FIG. 13 shows a schematic representation of a LiDAR system according to an aspect of the invention.

FIG. 14 shows a schematic representation of a LiDAR system according to a further aspect of the invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The invention provides a system for determining a temporal characteristic of a received light signal. The system comprises: a micromirror arranged to receive and reflect an optical input, wherein the micromirror is adapted to tilt between a first position and a second position; an optical sensor array arranged to receive light reflected by the micromirror at a position between the first position and at the second position; and a processor in communication with the micromirror and the optical sensor array, wherein the processor is adapted to: control the micromirror to tilt between the first position and the second position when the incoming light signal is received, thereby sweeping the reflected light across the optical sensor array to generate a swept light signal at the sensor array; and determine a temporal characteristic of the optical input based on the swept light signal.

There are many applications in which the temporal characteristics of an optical input may be of interest; however, it is not always possible to repeatedly provide the same optical input to a sensor in order to fully record the temporal characteristics of said optical input. This is particularly the case when attempting to investigate the properties of a short lived or unstable light source. For example, when performing spectroscopy of unstable light sources, such as decaying plasmas, it may not be possible to capture an optical input from the light source more than once.

The invention provides a means of capturing and investigating the temporal characteristics of an optical input in a single, near instantaneous operation. In particular, the rapid tilting of the micromirror from the first position to the second position causes the optical input to be swept across the sensor array, thereby spreading the optical signal over the surface of the sensor array, which provides a temporal profile of the optical signal array at the sensor face in a near instantaneous manner.

In other words, when the optical signal enters the system, the micromirror is at (or near) the first position and begins to tilt towards the second position. During this tilting motion, the incoming optical input is changing with time, as any optical signal will vary with time, and these changes in the signal with time are captured at different spatial points on the sensor array due to the movement of the mirror.

Therefore, the invention provides a means of capturing the full temporal evolution of an incoming optical signal at a sensor array in a single emission of the optical signal.

Each micromirror may be thought of as a small galvanometer mirror rapidly sweeping along a sweep path typically between −12° and +12°, or across 24°, with the potential to sweep a reflected incoming beam through 48° in a short time. It should be noted that micromirrors are produced with a range of angular sweep amplitudes and any size of angular seep from the first position to the second position may be used in the systems described herein, such as across 90° or less, such as 60° or less, such as 24° or less. Further, the lower the sweep angle, the faster the tilting of the micromirror from the first position to the second position. Accordingly, using a smaller angular sweep, such as 24°, it is possible to achieve an improved resolution of swept light signal. This rapid angular sweep may be used as part of an Angular Spatial Light Modulator and/or as a scanning component in a LiDAR system. In typical cases where a DMD is used in an Angular Spatial Light Modulator or a LiDAR system, a laser pulse is synchronized with the mirror transition and delayed so as to reflect at specific angles. The laser pulse is much shorter than the transition period, effectively freezing the mirror in position.

According to the present invention the intention is to use the angular sweep of the micromirrors as a method of performing temporal dispersion of the optical input, rather than to use the temporal dispersion as a method of angular sweep as in the lidar systems. If light reflected from the DMD mid-transition is swept across a sensor array, in its simplest form, the light “track” that is recorded at the sensor array will represent the temporal evolution of the light source during that sweep. In this form the DMD and sensor array may form a version of a streak camera.

As described above, the use of micromirrors and DMDs in systems for investigating optical signals is often avoided due to the complicated nature of the diffraction patterns results from the optical signals reflecting at the micromirrors, particularly in systems where there is an array, such as a 2D array, of micromirrors being used.

The invention further provides a means of interpreting the swept light signals in order to overcome the challenges faced by the diffraction patterns generated by the micromirrors by modelling the micromirrors as a diffraction grating, such as a blazed diffractions grating. In a specific example, which is described in further detail below, the micromirrors may be modelled as a blazed diffraction grating where the blaze angle of the modelled blazed diffraction grating changes over time, in conjunction with the tilting of the micromirrors from the first position to the second position.

Before the specific examples of the systems and methods of the invention, there is provided below a brief discussion of the interpretation of micromirror arrays as diffraction gratings.

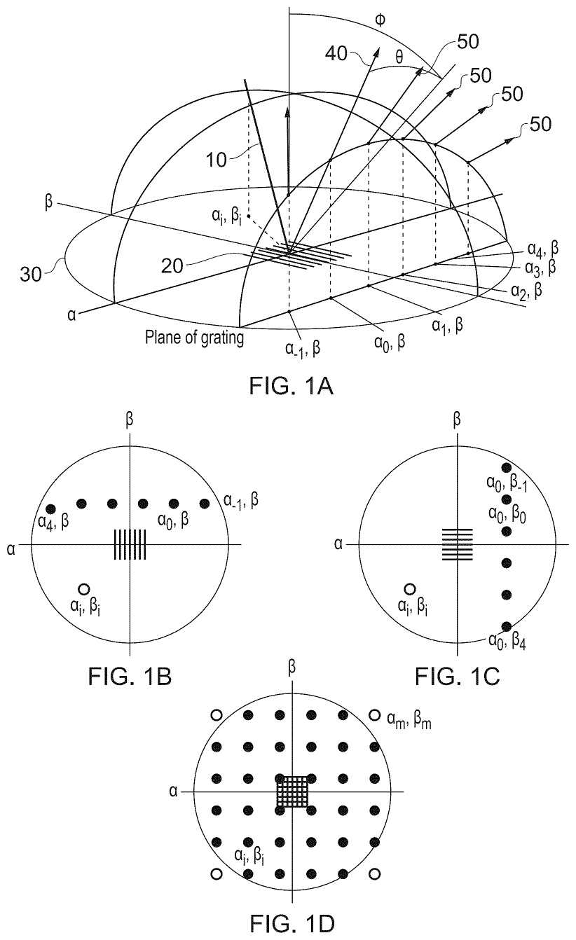

FIG. 1A shows a schematic representation of how the direction cosines of incoming and diffracted beams are represented. FIGS. 1B to 1D show schematic representations of the direction cosines of incoming and diffracted beams for vertical, horizontal and 2D diffraction gratings, respectively.

The incoming beam 10 may be considered relative to the geometry of the grating 20 may be quantified in terms of the direction cosines in the plane 30 of the grating. This is the point at which the incoming beam 10 strikes the unit circle and is projected down onto the plane of the grating 30. The direction cosines may be considered with respect to two orthogonal directions in the plane of the grating 30 given by two coordinates (α, β). For the purposes of illustration, the grating is considered as being aligned with the β axis, but this is an arbitrary selection, and the grating may have any alignment with respect to the two axes.

Direction cosines are defined as the cosines of the angles between the light beam vectors and the axes defining the space.

The beam 40 reflected and exiting close to specular reflection is considered to be the zeroth order diffraction and exits with the same amplitude of p as the incoming beam 10. Diffracted orders 50 are separated by an angle described by the formula:

$$angle = m \frac{λ}{d} ,$$

where: m is the diffraction order; λ is the wavelength of the incoming beam; and d is the grating feature spacing.

Therefore, the diffraction orders may be represented in direction cosine space as:

$${α}_{m} = {α}_{i} + m \frac{λ}{d} \qquad ( 1 )$$

$${β}_{m} = - {β}_{i} \qquad ( 2 )$$

$$where :$$

$${α}_{m} = sin {θ}_{m} cos {ϕ}_{0} \qquad ( 3 )$$

$${α}_{i} = - sin {θ}_{0} cos {ϕ}_{0} \qquad ( 4 )$$

$${β}_{i} = - sin {ϕ}_{0} \qquad ( 5 )$$

where θ and Φ are orthogonal angles with θ₀ being the direction of the zeroth order in the α direction and ϕ₀ the angle in the β direction. The subscript i refers to the input beam direction.

The distributions of direction cosines of diffraction orders in the grating plane are shown schematically in FIGS. 1B and 1C, which show the positions of the diffraction orders when the grating orientation differs by 90 degrees with respect to the incoming beam direction. It should be noted that that the illustrated positions of the diffraction orders represent the possible beam directions for diffraction, but do not reflect the amplitude of the orders, which will be geometry dependent. A two-dimensional grating such as a DMD will produce a 2D set of diffraction orders as shown in FIG. 1D. Orders that fall outside of the unit circle are considered to be evanescent.

The depicted map of diffraction order positions shown in FIGS. 1B to 1D are linear due to projection onto the unit sphere and, in the real world where such orders may be viewed on a flat screen, the order spacing will become non-linear. However, the linear spacing provides a usable way of modelling diffraction effects on a DMD. A grid can be produced in cosine direction space representing the diffraction orders and the intensities at each diffraction order may be modulated to represent particular diffraction characteristics, such as those that are influenced by the mirror angles, which behave like a blazed diffraction grating.

The angular spacing between orders is

$$Δθ = \frac{λ}{d} \qquad ( 6 )$$

and thus the number of orders in one direction may be given by the formula:

$$floor ( \frac{1}{Δ θ} ) \qquad ( 7 )$$

The diffraction orders can be represented by a 2D comb function given by the formula:

$$orders = δ ( m Δθ , n Δθ ) \qquad ( 8 )$$

and the diffraction orders are bounded within a circle such that:

$$\begin{matrix}orders = 1 {if ( m Δθ )}^{2} + {( n Δθ )}^{2} \leq 1 \\ = 0 otherwise\end{matrix} \qquad ( 9 )$$

The micromirrors are at a blaze angle of −12° when off and +12° when on, such that they sweep across an angle of 24°. As discussed above, any sweep angle may be utilized according to the micromirror being used in the system. The tiling of the micromirror from the first position to the second position defines a sweep path having a sweep angle between a first axis, which is an axis normal to the plane defined by the surface of the mirror at the first position, and a second axis, which is an axis normal to the plane defined by the surface of the mirror at the second position. In some embodiments the sweep angle may be 40° or less, in some embodiments the sweep angle may be 30° or less. In particular, the sweep angle may be less than or equal to 24°. The closest order number to the reflected (local zero) order is given by:

$$n int ( 2 \times \frac{{θ}_{b}}{Δθ} ) \qquad ( 10 )$$

shere θ_{b} is the blaze angle and nint( ) is nearest integer. The envelope of intensity distributions is determined by the mirror size, w, and the mirror spacing, e:

$$I ( θ ) = sin c {( \frac{θ - {θ}_{b}}{Δθ} \frac{w}{w + e} )}^{2} \qquad ( 11 )$$

and is centered about the blaze order.

Thus the intensity distribution is given by:

$$I ( θ ) \times orders \qquad ( 12 )$$

in direction cosine space. In the real world each order has a physical beam size that is related to the input beam size incident on the micromirrors and ignoring diffraction effects from any pattern present on the DMD.

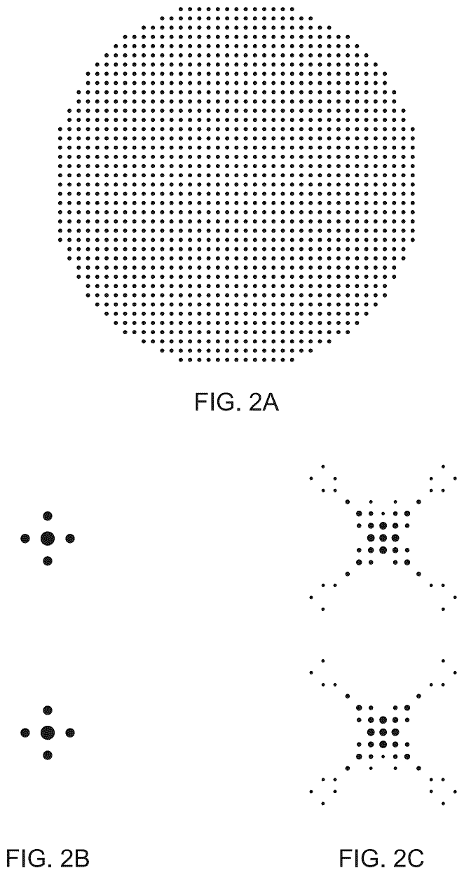

FIG. 2A shows an illustration of a full diffraction order space for a DMD and an optical input having a wavelength of 635 nm with the color scale inverted for clarity. FIG. 2B shows the full diffraction order space for a DMD in the off and on positions. FIG. 2C shows a saturated version of the center of the full diffraction order space shown in FIG. 2A and representing a view more commonly seen when observing by the diffraction orders by eye.

FIGS. 2A to 2C show how the cosine space is populated with allowed orders and how the blazed nature of the mirrors in OFF and ON positions selects a subset of these allowed orders. In particular, the examples shown in FIGS. 2A to 2C show the intensity distributions for mirrors of 10.8 μm in size with a spacing of 1 μm and for an optical input having a wavelength of 635 nm. The full scale representation of FIG. 2A represents the full direction cosine space which covers roughly ±19 orders. The mirror tilt direction is vertical in the examples shown in FIGS. 2A to 2B with the mirror x and y axes at 45°, which can be seen in the example shown in FIG. 2C, which is overexposed showing many of the weaker orders at 45° to the tilt direction, and represents a more complex view most often seen by users reflecting lasers from a DMD.

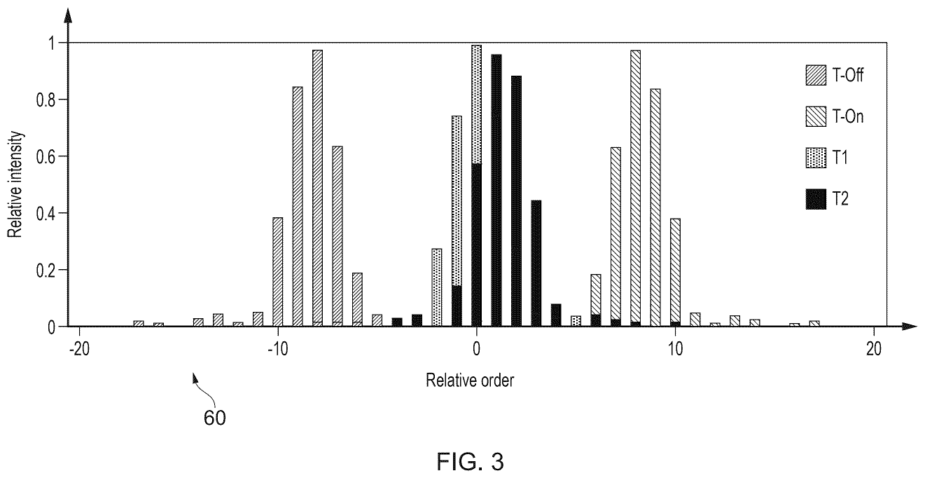

FIG. 3 shows a plot 60 of relative intensity against relative order, which represents the diffraction order distributions of a DMD as the mirrors transition between initial state T0 to final state T′ via intermediate states T1 and T2.

As the micromirrors transition between the Off and On states, the envelope function of equation 11 transitions between the 2 states, populating the orders between them. The blaze order then becomes time dependent:

$$I ( θ ) = sin c {( \frac{θ - {θ}_{b} ( t )}{Δθ} \frac{w}{w + e} )}^{2} \qquad ( 13 )$$

The time dependence of the blazer order function is shown in FIG. 3 where two close times (T1 and T2) are displayed as overlapping near the center of the plot, with the OFF and ON positions also shown. This one-dimensional plot is made along the tilt axis plane, i.e., along the same plane as the sweep angle of the micromirrors. If the transition time of the micromirrors is known, then the order intensity distribution can be used to determine the relative time of the given order intensity distribution from the transition start, in whichever direction the mirror is moving.

To observe an isolated diffraction order at an intermediate position, between the OFF (first) and ON (second) positions, would require a pulsed laser to freeze the diffraction order in position. The relative delay of the laser pulse determines the position of the diffraction order. The length of the laser pulse causes a broadening of the individual diffraction orders and is a convolution of the pulse width and the order size, where the pulse width time is translated into an angular spread with a timescale related to the ratio of the pulse width to the transition time.

From the plot shown in FIG. 3, it can be seen that the sweeping action of the rotating mirror sweeps the diffraction envelope function across the permissible orders, meaning that inferring temporal pulse properties, such as pulse width, will require a measurement of the envelope function and an accurate understanding of the intrinsic envelope function which is being convolved with a pulse.

The approach outlined above represents a straightforward way of understanding the diffraction effects from a 2D dynamic blazed grating. A DMD is however not a true blazed grating as it directs light into multiple orders and so is only similar to a blazed grating. However, as discussed in further detail below, simpler diffraction results can be obtained when using just a single mirror or a 1D line of transitioning mirrors.

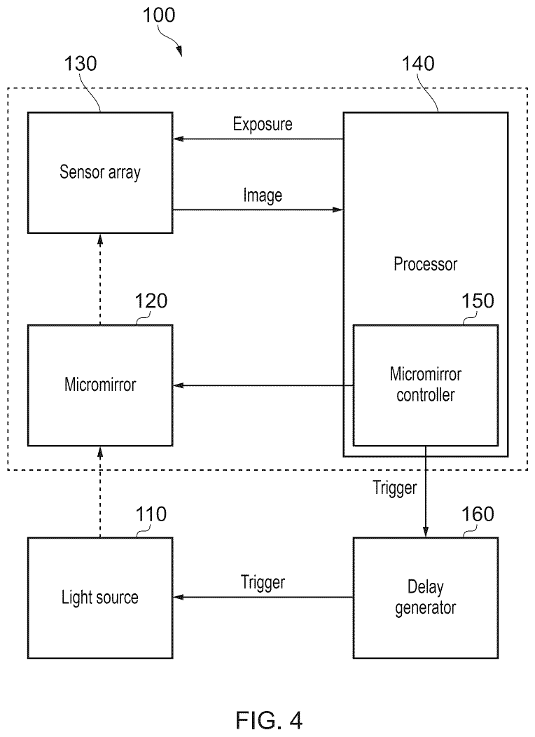

Several of the FIGS. provided below illustrate results from an example system according to an aspect of the invention. FIG. 4 illustrates a schematic representation of a system according to an aspect of the invention and various implementation options for such a system are provided below.

FIG. 4 shows a system 100 for determining a temporal characteristic of a received light signal, received for example from a light source 110, which may be external to the system 100, and controller by way of a delay generator 160, which may be controlled through communication with the system processor 140. The system includes a micromirror 120 arranged to receive and reflect an optical input, wherein the micromirror is adapted to tilt between a first position and a second position as described above.

The system 100 further includes an optical sensor array 130, such as a camera sensor, arranged to receive light reflected by the micromirror 120 at both the first position and at the second position. The system 100 also includes a processor 140 in communication with the micromirror 120 and the optical sensor 1 array 30. The processor may include a micromirror 150 adapted to control the micromirror 120 to tilt between the first position and the second position when the incoming light signal is received, thereby sweeping the reflected light across the optical sensor array 130 to generate a swept light signal at the sensor array. The processor is further adapted to determine a temporal characteristic of the optical input based on the swept light signal.

The temporal dispersion of the optical input that can be observed with a micromirror 120 and sensor array 130 arrangement as shown in FIG. 4 is analogous to a streak camera and will be referred to as a micromirror array-based streak camera (MASC) herein. However, as discussed above, the temporal characteristics of the optical input reside in the characteristics of the envelope of the light signal (i.e. envelope central position, envelope width and the like) across discrete diffraction orders. A continuous temporal dispersion can be obtained by flipping a single micromirror from the first position to the second position as no collective diffraction from the array is involved in this case.

Alternatively, it is possible to flip a single line of micromirrors, i.e., a one-dimensional array of micromirrors, oriented orthogonally to the tilt direction (also referred to as the sweep path of the micromirrors). In this case, the temporal dispersion visible in the swept light signal remains continuous and any collective diffraction that occurs orthogonally to the swept light signal. All three approaches (a single micromirror, a one-dimensional array of micromirrors and a two-dimensional array of micromirrors) are discussed in further detail below.

In the examples provided herein, the DMD system used to generate the experimental results had an array size of 1024×768 pixels. The processor for the example system was adapted for the writing of image frames as 1 bit images or multi bit images with an equivalent pulse width modulation function used to control the signal amplitude. The device head was mounted in a 3D printed support with the DMD rotated at 45°, allowing the diagonal mirror pivots to be parallel to the optical table. The system processor was adapted to generate an output trigger pulse when the mirrors begin to transition. The light source 110 used was a variable pulse width laser capable of selecting pulse widths between 5 ns and 129 ns with a wavelength of 640 nm at a triggerable rate up to 50 kHz. The processor 140 was in communication with a delay generator 160 to provide precise delay and pulse control for triggering the laser.

In the examples provided herein, a monochrome USB camera (1.3 Megapixel, 10 bit) was used to capture the images. The processor 140 was adapted to write binary frames for the choice of micromirrors within the DMD array to use and the picture time for which the micromirrors are held in the second position. The processor also controlled the image captured by the sensor array 130 and the exposure time. The delay used to trigger the light source, and the pulse width produced by the laser were controlled manually.

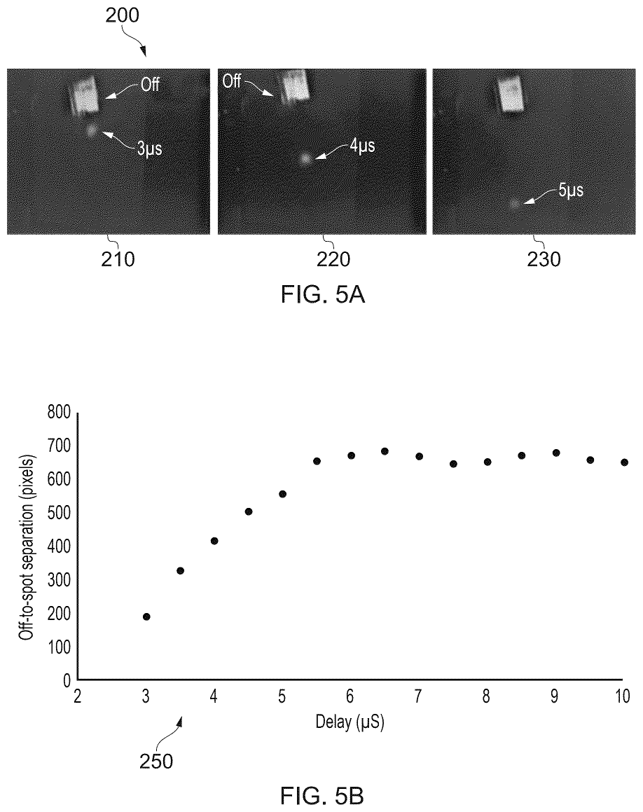

FIG. 5A shows a series of images 200 illustrating the reflected beams from a single micromirror transitioning from the first position to the second position at different delay times. The first image 210 shows a beam reflected by the micromirror in the first position and a beam reflected by the micromirror during the transition between the first position to the second position with a light source delay of 3 μs. The second image 220 shows a beam reflected by the micromirror in the first position and a beam reflected by the micromirror during the transition between the first position to the second position with a light source delay of 4 μs. The third image 230 shows a beam reflected by the micromirror in the first position and a beam reflected by the micromirror during the transition between the first position to the second position with a light source delay of 5 μs.

In the example images shown in FIG. 5A, a microscope objective was used to focus the light into a small spot and a single micromirror of the DMD was tilted from the first position to the second position, with the reflected beam being observed on a screen and a camera capturing the screen image. The large divergence from the DMD, coupled with the close proximity of the microscope objective made direct capture onto the camera sensor impossible. A single reflected beam spot could be observed whose position varied with the chosen delay, as can be seen in the series of images 200 shown in FIG. 5A. The OFF position, or the first position, is seen in each image because the micromirrors always return to the off position before each frame and the camera is integrating. By measuring the distance between the delayed beam spot and the reflection of the micromirror in the first position, an estimate for the transition time of the micromirror can be obtained.

FIG. 5B shows a plot of the distance between the beams reflected by the micromirror in the first position and the during the transition between the first position to the second position against the delay time of the light source. The plot 250 in FIG. 5 shows the displacement as a function of delay time. The micromirror appears to complete its transition from the first position to the second position after 6 μs, but then shows evidence of a slight bounce before settling at around 10 μs. There appears to be a 2 μs delay before the mirror begins to move, relative to the output trigger.

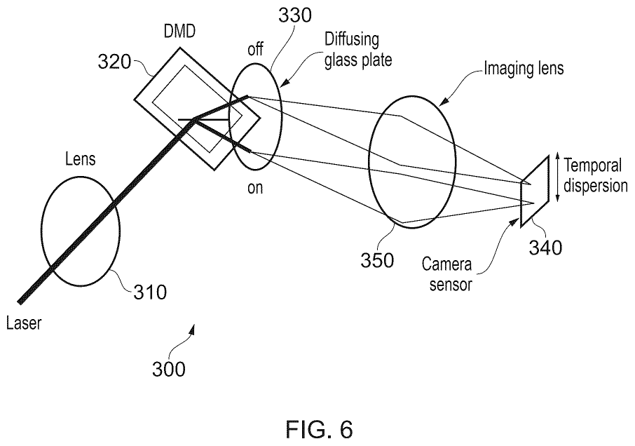

FIGS. 6 to 8 relate to examples where a one-dimensional array of micromirrors of the DMD is tilted from the first position to the second position. In the examples discussed below, the systems comprise a plurality of micromirrors adapted to receive the incoming light signal, wherein each micromirror of the plurality of micromirrors is adapted to tilt between a first position and a second position to sweep the light signal across the sensor array. In the examples shown in FIGS. 6 to 8, the one-dimensional array of micromirrors is selected to be aligned orthogonal to the sweep path of the micromirrors.

FIG. 6 shows a schematic representation of a system 300 for determining a temporal characteristic of a received light signal according to an aspect of the invention.

The system shown in FIG. 6 comprises a first lens 310 to focus a pulsed laser coincident with a one-dimensional array of micromirrors of the DMD 320, wherein the one-dimensional array of micromirrors is orthogonal to the tilt direction of the micromirrors. The beams reflected by the one-dimensional array of micromirrors are intercepted by a diffusing glass screen 330 positioned close to the DMD 320, for example 2 cm from the DMD, such that the beams reflected from the micromirrors at the first and second positions are both incident upon the diffusing glass screen. Light scattered from the diffusing glass screen 330 is focused on to a sensor array 340, such as a camera sensor, by way of an imaging lens 350.

The diffusing glass screen 330 is entirely optional in the examples described herein and may be omitted such that the swept light signal is swept directly onto the surface of the sensor array 340. Alternatively, in place of the diffusing glass screen, there may be provided any alternative means of optical signal transmission for transmitting the swept optical signal from the DMD to the sensor array.

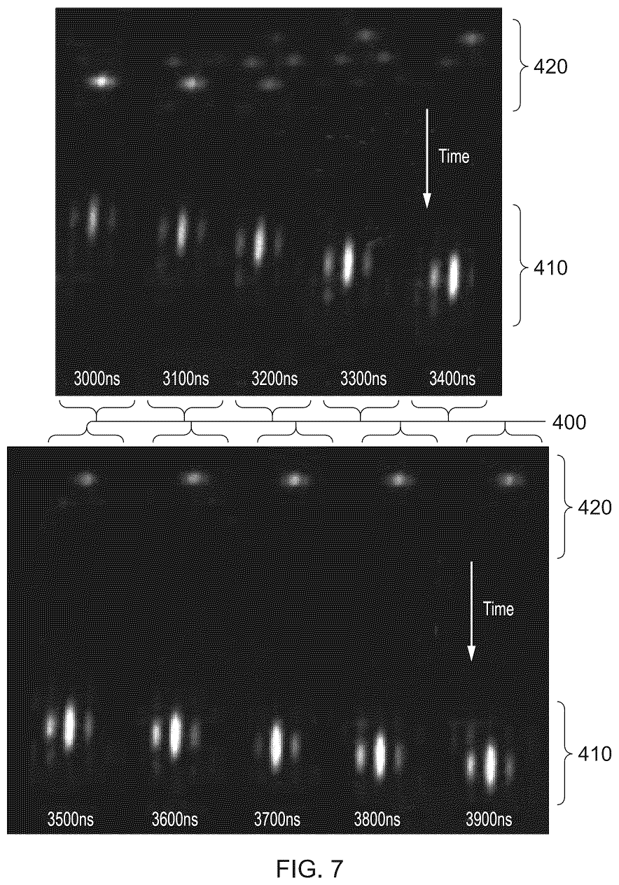

FIG. 7 shows a series of false color images 400 captured by a monochromatic camera illustrating the reflected beams received at the sensor array of FIG. 6 for differing light source delay times, in steps of 100 ns. The images 400 show a diffraction pattern 410 predominantly in the horizontal direction, the same direction as the one-dimensional array of micromirrors. It should be noted that because the focal spot size is greater than a single mirror, there is a residual structure 420 from diffraction off the neighboring micromirrors adjacent to the one-dimensional array of micromirrors in use, which remain in the first position. Further, the diffusing glass screen scatters light predominantly in the forward direction and gives the strongest signals in the center of the diffraction patterns 420, typically around the 4 μs point. The result of this investigation illustrates the ability for the system to be calibrated along the time direction at 10 ns/pixel. With the delay fixed to place the beam centrally, images were captured of the reflected beam with differing pulse widths.

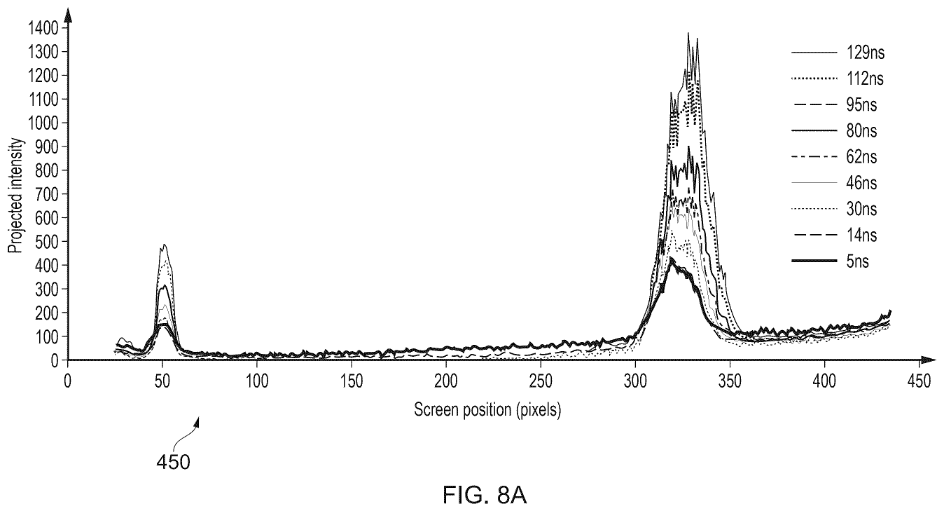

FIG. 8A shows a graph 450 of projected intensity against screen position showing plots illustrating of vertical projections of intensity distribution for images with differing optical input pulse widths.

From the images 400 of FIG. 7, the vertical intensity of the swept light signals is projected as illustrated in the plots of the graph 450 in FIG. 8A. As shown by the plots of graph 450, when the pulse width of the optical input is reduced so is the pulse energy, which results in a reduction in the projected intensity. A Gaussian function may be fit to the projected intensity plots in order to extract the center position and width of the envelope of the optical input. FIG. 8B shows a plot 460 of projected image width against optical input pulse width. At the smallest image widths, the image is dominated by the intrinsic width of the reflected beam, with the pulse width effect being at a sub-pixel resolutions.

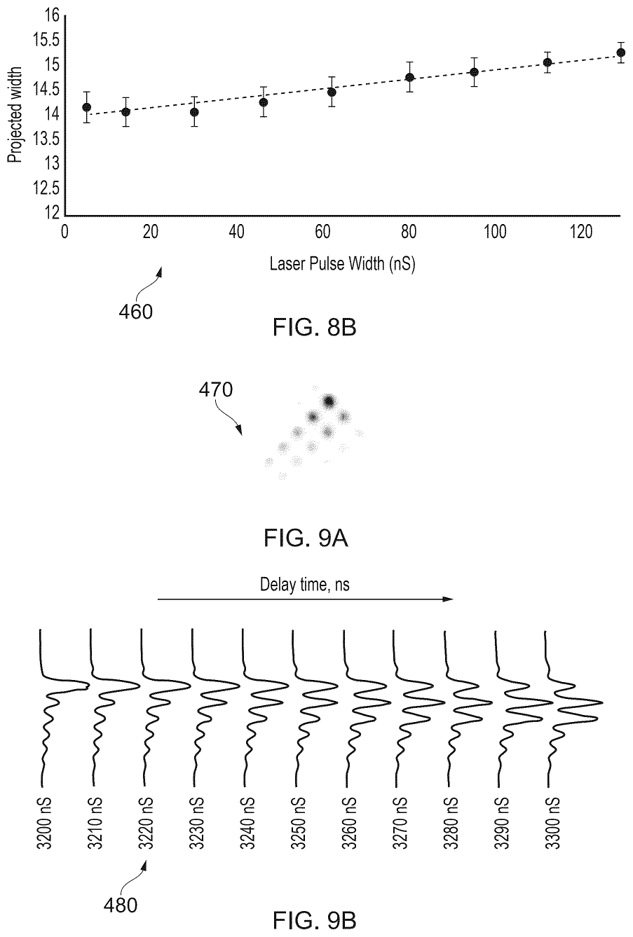

FIGS. 9 to 12 relate to examples where a two-dimensional array of micromirrors is tilted from the first position to the second position.

Switching multiple lines of micromirrors from the first position to the second position at once will result in a complicated two-dimensional diffraction pattern as discussed above, but it will have the advantage of higher intensity signals as more of the incident power of the incoming optical input is reflected in the sweep of the micromirrors. In order to interpret the temporal characteristics of the optical input, the centroid of the whole received diffraction pattern needs to be related to the temporal position of the swept light signal. As for the one-dimensional array of micromirrors, the vertical intensity is projected and the centroid calculated for a known delay applied to the laser pulse.

FIG. 9A shows a captured diffraction pattern 470 from a two-dimensional array of micromirrors tilting from the first position to the second position. FIG. 9B shows a set of projected vertical intensities showing how the intensity of the diffraction pattern evolves for delay increments of 10 ns. FIG. 9C shows a plot of centroid position of the diffraction pattern against delay, which is approximately linear as shown by the plot. However, the images of diffraction patterns do not show a smooth evolution, as might be inferred from the asymmetric intensity distribution shown in FIG. 9A.

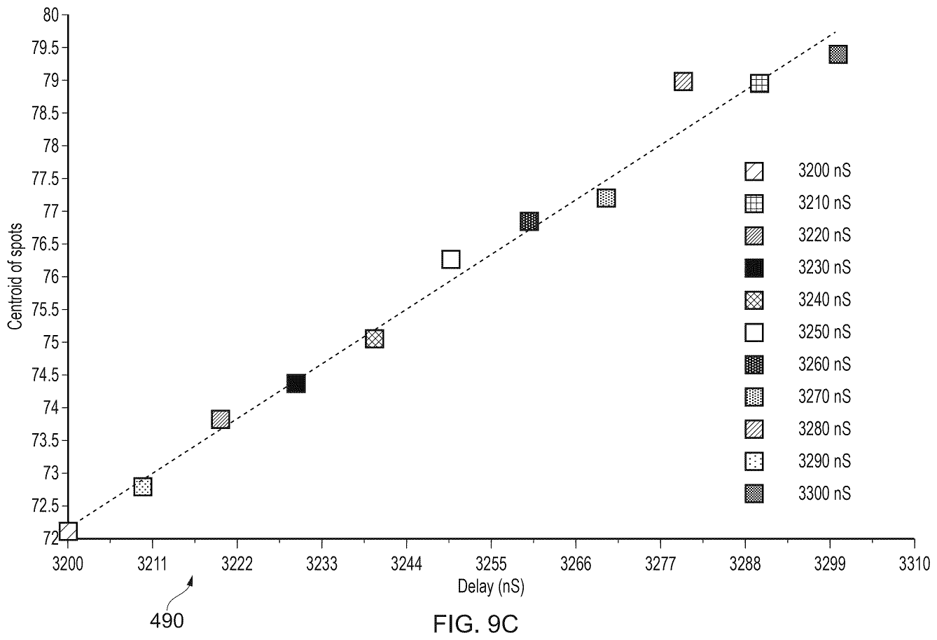

FIG. 10 shows a schematic representation of a system 600 for determining a temporal characteristic and a spectral characteristic of a received light signal according to an aspect of the invention.

Similar to the system shown in FIG. 6, the system of FIG. 10 comprises a first lens 610 to focus a pulsed laser coincident with a two-dimensional array of micromirrors of the DMD 620. The beams reflected by the two-dimensional array of micromirrors are intercepted by a diffusing glass screen 630 positioned close to the DMD 620, for example 2 cm from the DMD, such that the beams reflected from the micromirrors at the first and second positions are both incident upon the diffusing glass screen. Light scattered from the diffusing glass screen 630 is focused on to a sensor array 640, such as a camera sensor, by way of an imaging lens 650.

Pre-dispersing the incoming optical signal with a diffraction grating 660 before it interacts with the DMD allows both spectral, for example chromatic, and temporal characteristics of the optical input signal to be observed. In the examples described with respect to FIGS. 10 to 12, a blazed diffraction grating having 300 lines/mm is provided to disperse light received from a fiber collimator 670 in a direction orthogonal to the temporal dispersion.

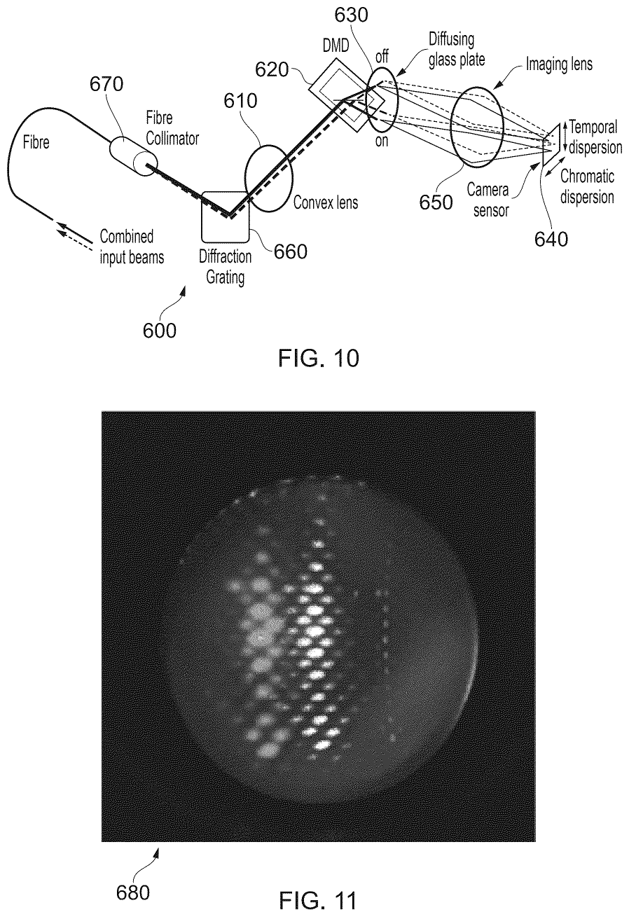

FIG. 11 shows an image 680 illustrating the chromatic dispersion of red, green and blue continuous lasers from a photo of the dispersing glass plate in FIG. 10. To demonstrate the chromatic dispersion of the system 600, three different lasers were combined using beam splitters and focused into a single mode fiber. The wavelengths red (632 nm), green (532 nm) and blue (405 nm) were used to show the extent of the chromatic dispersion; however, as the lasers are all continuous there is no temporal dispersion to be shown. The grating was chosen to show the range of wavelengths together on the diffusing glass; however, a more finely ruled grating with greater dispersion would have better spectral resolution if required. From the image 680 in FIG. 11, it can be seen that the diffraction orders follow a curved path which can be described with a quadratic function. The order spacing is seen to reduce as expected for shorter wavelengths. This chromatic dispersion may then be used to calibrate a horizontal wavelength scale.

In order to demonstrate both the temporal and spectral dispersion at the same time a single pulsed laser cannot be used, and a white LED may be used in place of the lasers described above. The white LED may be connected directly to a pulse generator, producing 1 μs long pulses with a controllable delay relative to the tilting of the micromirrors between the first and second positions. In the example shown in FIG. 10, the optical input is delivered to the DMD 620 from the fiber collimator 670, which requires the use of a multi-mode (50 μm core) fiber butted against the LED to collect as much light as possible. The use of a multi-mode fiber produces larger image spots and reduces resolution compared to a laser.

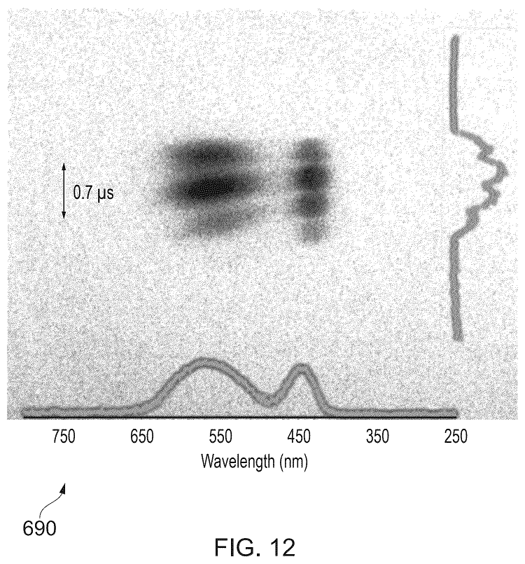

FIG. 12 shows an image 690 of the diffraction pattern of a pulsed white LED showing spectral and temporal dispersion. FIG. 12 includes a projection in the wavelength direction shown below the image and a projection in the time direction to the side of the image. The wavelength projection shown in FIG. 12 is taken in a region through the center of the of the image, with the wavelength calibration made using the same region using known wavelength lasers similar to FIG. 11 and a monochrome camera. The temporal scale was established using images captured with different delays (3.3 μs, 3.7 μs and 4.0 μs) with the image shown being delayed by 3.7 μs. The projection shown is for the right hand cluster of diffraction features and the centroid for each image was found from within this region, allowing the temporal scale to be determined as marked on the FIG.. This is intended only to demonstrate the principle of simultaneous wavelength and time dispersion and the production of a λ-t map. The spectral distribution shows good agreement with the expected spectrum for a cool white LED, with a blue LED source around 450 nm and a yellow phosphor at longer wavelength.

Therefore, by including a diffraction grating before the optical input reaches the DMD, the incoming light can be pre-dispersed in a direction orthogonal to the sweep direction, such that the “image” recorded by the sensor array is an instantaneous two-dimensional map of the temporal and spectral characteristics of the optical input.

The rapid change of tilt state of an array of micromirrors has been the key factor in the success of the DMD enabling its ability to rapidly rewrite spatial patterns. However, for the reasons outlined previously, the accompanying sweep of a reflected beam as the micromirrors transition between first and second positions has not been utilized. The systems and methods described in detail above shows that capturing a swept light signal with a sensor array allows the temporal properties of an optical source to be captured and interpreted if the complex diffraction patterns of the swept light signals can be modelled and accounted for. The combination of DMD micromirror array and camera sensor detector array forms a version of a streak camera, but made from relatively low cost components. The micromirror array behaves in a fashion similar to a dynamic blazed diffraction grating where the blaze angle varies with time as the micromirrors tilt from the first position to the second position.

The examples discussed above have shown a swept light signal observed from: a single micromirror, which avoids the diffraction structures; a one-dimensional array of micromirrors, with a diffraction pattern structure in a direction orthogonal to the sweep angle of the one-dimensional array of micromirrors; and a two-dimensional array of micromirrors, where the reflected optical power envelope moves across diffraction orders. Using the one-dimensional array of micromirrors, the observed temporal ‘streak’ length correlates with the controlled pulse width from a laser. In the setup chosen for the examples discussed above, the pulse width was measurable down to 20 ns where the image width became sub-pixel for the camera sensor. Using the two-dimensional array of micromirrors, signal envelope shifts corresponding to 10 ns of temporal shift were observed. By pre-dispersing the incident light the streak camera could observe both wavelength and temporal characteristics. Whilst a pulsed laser is ideal for demonstrating the temporal dispersion ability of the streak camera, a multi-wavelength pulsed source is required to demonstrate the combined wavelength and temporal dispersion. A white light LED was used for this purpose, where a 1 μs pulse was coupled into a multi-mode fiber and dispersed.

The temporal resolution in the examples discussed above was defined by the distance of the diffusing glass screen from the DMD and was chosen to encompass the majority of the first position to second position transition of the micromirror tilt within the field of view of the camera. Moving the screen and camera further from the DMD reduces the captured temporal dynamic range but improves the temporal resolution, which could achieve sub nanosecond temporal resolution. The spectral resolution was determined by the pre-dispersion grating, which again was chosen for a wide capture range (covering the optical input wavelengths of red to blue) to demonstrate the concepts discussed above. The use of a finer diffraction grating improves the spectral resolution at the expense of instantaneous spectral range. The forward scatter function of the diffusing glass screen affects the apparent brightness of the swept light signal, reducing intensity away from the center of the diffraction patter; however, this is beneficial as it suppresses the endpoints, which can be much brighter than the transition.

The micromirror array-based streak camera, i.e., the systems and methods of the invention described above, can find application for characterizing an optical input, such as a received unknown laser source, but could be particularly well suited for use with spectroscopy. Whilst spectral contributions can be discriminated, they tend to be collected within a common time window. In cases such as laser induced breakdown spectroscopy spectral contributions can appear at different times—as a laser induced plasma cools and excited atoms cascade down through energy levels—but this cannot be seen without temporal discrimination, which can be achieved using the methods and systems described above. This technique could also be applicable to fluorescence studies where fluorescence lifetimes are relatively long. The micromirror array based streak camera can in principle capture temporal and spectral data in a single emission overcoming the need for repetition and sample damage.

As well as spectroscopy, the methods and systems described above may find application within LiDAR systems. LiDAR systems are adapted to determine ranges, or distances, by targeting an object or a surface with a laser and measuring the time for the reflected light to return to a receiver.

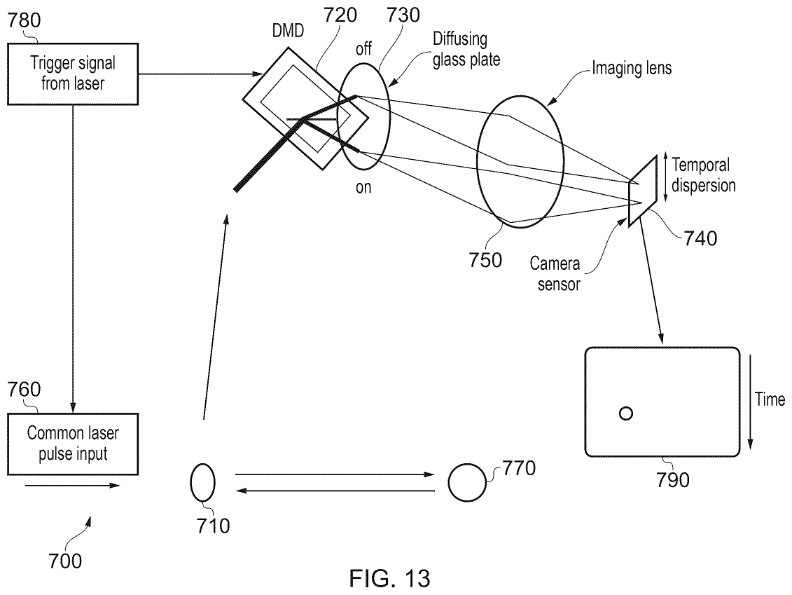

FIG. 13 shows a schematic representation of a LiDAR system 700 according to an aspect of the invention.

Similar to the system shown in FIGS. 6 and 10, the system of FIG. 13 comprises a first lens 710 to focus a pulsed laser coincident with an array of micromirrors of the DMD 720, which may be a single micromirror, a one-dimensional array or a two-dimensional array of micromirrors. The beams reflected by the array of micromirrors are intercepted by a diffusing glass screen 730 positioned close to the DMD 720, for example 2 cm from the DMD, such that the beams reflected from the micromirrors at the first and second positions are both incident upon the diffusing glass screen. Light scattered from the diffusing glass screen 730 is focused on to a sensor array 740, such as a camera sensor, by way of an imaging lens 750.

In the example shown in FIG. 13, the system 700 further includes a light source 760 adapted to generate an output light signal and wherein the optical input is a reflection of the output light signal from a surface 770, or object, external to the system. The light source 760 and the DMD 720 may be controlled by a trigger 780. Further, the first lens 710 performs the function of focusing the output light signal as it leaves the system and focusing the optical input as it returns to the system after being reflected by the external surface 770. The system may include a fiber optic circulator for directing the light in and out of the LiDAR system 700. The angular sweep of the DMD 720 gives temporal dispersion registered on the sensor array, the temporal delay measuring the distance between the LiDAR system 700 and the object 770 as shown in plot 790. In the case of the system of FIG. 13, the temporal characteristic comprises a time-of-flight measurement.

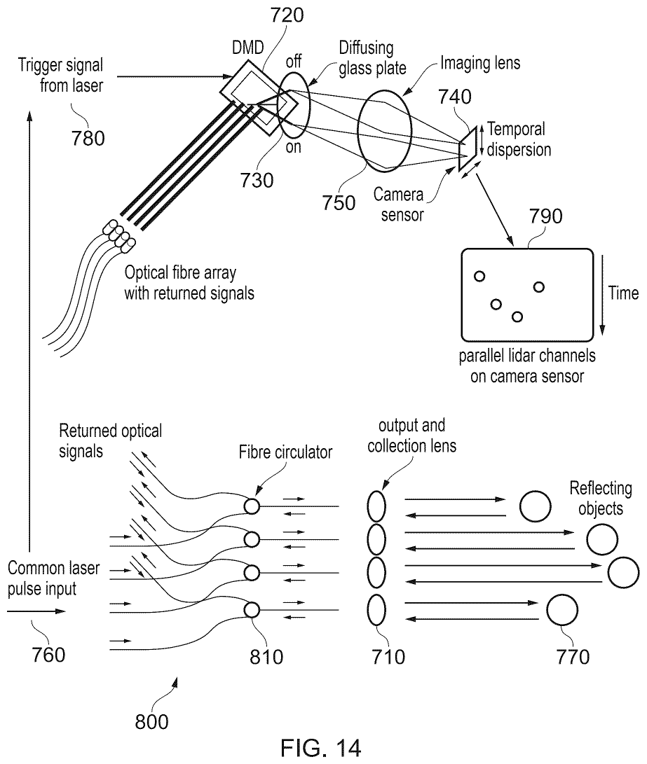

FIG. 14 shows a schematic representation of a LiDAR system 800 according to a further aspect of the invention.

Similar to the system shown in FIG. 13, the system 800 of FIG. 14 comprises a first lens 710 to focus a pulsed laser coincident with an array of micromirrors of the DMD 720, which may be a single micromirror, a one-dimensional array or a two-dimensional array of micromirrors. The beams reflected by the array of micromirrors are intercepted by a diffusing glass screen 730 positioned close to the DMD 720, for example 2 cm from the DMD, such that the beams reflected from the micromirrors at the first and second positions are both incident upon the diffusing glass screen. Light scattered from the diffusing glass screen 730 is focused on to a sensor array 740, such as a camera sensor, by way of an imaging lens 750.

Further, the system 800 includes a light source 760 adapted to generate an output light signal and wherein the optical input is a reflection of the output light signal from a surface 770, or object, external to the system. The light source 760 and the DMD 720 may be controlled by a trigger 780. Further, the first lens 710 performs the function of focusing the output light signal as it leaves the system and focusing the optical input as it returns to the system after being reflected off of the external surface 770.

The system 800 further comprises a fiber circulator 810 adapted to direct a laser pulse through the first lens 710 to the object 770 that reflects the light signal. The reflected light is collected by the same lens and the fiber circulator 810 directs the optical input towards the DMD 720. In other words, the optical fiber circulator is adapted to receive the generated output light signal from the light source, output a plurality of output light signals based on the received generated output light signal; and receive a plurality of reflected light signals as optical inputs in parallel. The plurality of optical inputs is provided to the micromirror, and the processor is adapted to determine a plurality of time-of-flight measurements from the resultant plurality of swept light signals. The multi-channel LiDAR overlaps many fiber channels onto the same DMD and sensor array arrangement. All of the parallel LiDAR channels can be read on the same sensor frame as illustrated in plot 790.

Thus, the LiDAR system 800 shown in FIG. 14 provides a means of measuring the time-of-flight measurements between a plurality of objects in a parallel manner, thereby greatly improving the speed and efficiency of the illustrated LiDAR system over conventional LiDAR systems.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilized for realizing the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

What is claimed is:

1. A system comprising:
a micromirror arranged to receive and reflect an optical input, wherein the micromirror is adapted to tilt between a first position and a second position;
an optical sensor array arranged to receive light reflected by the micromirror at a position between the first position and at the second position; and
a processor in communication with the micromirror and the optical sensor array, wherein the processor is adapted to:
control the micromirror to tilt between the first position and the second position when the optical input is received, thereby sweeping the reflected light across the optical sensor array to generate a swept light signal at the optical sensor array; and
determine a temporal characteristic of the optical input based on the swept light signal.

2. The system of claim 1, wherein the optical sensor array comprises a camera sensor.

3. The system of claim 1, wherein the micromirror is further adapted to tilt between the second position and the first position, and wherein the processor is further adapted to:
control the micromirror to tilt between the first position and the second position and between the second position and the first position when the optical input is received, thereby sweeping the reflected light across the optical sensor array to generate an extended swept light signal at the optical sensor array; and
determine a temporal characteristic of the optical input based on the extended swept light signal.

4. The system of claim 1, wherein the system comprises a plurality of micromirrors adapted to receive the optical input, wherein each micromirror of the plurality of micromirrors is adapted to tilt between the first position and the second position.

5. The system of claim 4, wherein:
the plurality of micromirrors is arranged in a one-dimensional array; and
tilting of each micromirror of the plurality of micromirrors from the first position to the second position defines a sweep path having a sweep angle between a first axis, which is an axis normal to a plane defined by a surface of each micromirror of the plurality of micromirrors at the first position, and a second axis, which is an axis normal to a plane defined by the surface of each micromirror of the plurality of micromirrors at the second position, and wherein the one-dimensional array is arranged orthogonal to the sweep path.

6. The system of claim 4, wherein the plurality of micromirrors is arranged in a two-dimensional array.

7. The system of claim 1, wherein the system further comprises a diffraction grating provided between the optical input and the micromirror.

8. The system of claim 7, wherein the diffraction grating is a blazed grating.

9. The system of claim 1, wherein the temporal characteristic comprises a time-of-flight measurement.

10. The system of claim 1, wherein the system further comprises a light source adapted to generate an output light signal and wherein the optical input is a reflection of the output light signal from a surface external to the system.

11. The system of claim 10, wherein the system comprises an optical fiber circulator adapted to:
receive the output light signal generated by the light source;
output a plurality of output light signals based on the received output light signal; and
receive a plurality of reflected light signals as a plurality of optical inputs.

12. The system of claim 11, wherein the plurality of optical inputs is provided to the micromirror, and wherein the processor is adapted to determine a plurality of time-of-flight measurements from a plurality of swept light signals.

13. A method for determining a temporal characteristic of an optical input, the method comprising:
controlling a micromirror to tilt between a first position and a second position when the optical input is received, wherein the micromirror is adapted to receive and reflect the optical input;
obtaining a swept light signal from an optical sensor array arranged to receive light reflected by the micromirror at a position between the first position and at the second position; and
determining the temporal characteristic of the optical input based on the swept light signal.

14. The method of claim 13, wherein the micromirror is one of a plurality of micromirrors, the method further comprising controlling each micromirror of the plurality of micromirrors to tilt between the first position and the second position when the optical input is received.

15. The method of claim 13, wherein determining the temporal characteristic of the optical input comprises determining a reflected pattern of the swept light signal.

16. The method of claim 15, wherein determining the reflected pattern of the swept light signal comprises determining a diffraction pattern of the swept light signal by applying a blazed diffraction grating model to the swept light signal, wherein the blazed diffraction grating model comprises a model of a diffraction pattern from a blazed diffraction grating.

17. The method of claim 16, wherein:
the micromirror is one of a plurality of micromirrors;
the blazed diffraction grating model comprises a time varying blaze angle function; and
a blaze angle of the blazed diffraction grating model changes over time as each micromirror of the plurality of micromirrors tilts from the first position to the second position.

18. The method of claim 13, wherein determining the temporal characteristic of the optical input comprises analyzing an intensity profile of the swept light signal.

19. The method of claim 13, further comprising determining a spatial characteristic of the optical input based on the swept light signal.

20. The method of claim 19, wherein determining the spatial characteristic of the optical input comprises one or more of:
determining a spectral dispersion of the swept light signal; or
determining a source dispersion of the optical input based on the swept light signal.
